(19) United States
(12) Patent Application Publication
(10) Pub. No.: US 2015/0221341 A1
(43) Pub. Date: Aug. 6, 2015

(54) SYSTEM AND METHOD FOR ENHANCED TIME-LAPSE VIDEO GENERATION USING PANORAMIC IMAGERY

(71) Applicants: AUDI AG, Ingolstadt (DE); VOLKSWAGEN AKTIENGESELLSCHAFT, Wolfsburg (DE)

(72) Inventor: Sinan AKAY, Menlo Park, CA (US)

(73) Assignees: AUDI AG, Ingolstadt (DE); VOLKSWAGEN AKTIENGESELLSCHAFT, Wolfsburg (DE)

(21) Appl. No.: 14/169,546

(22) Filed: Jan. 31, 2014

(51) Int. Cl. G11B 27/036; H04N 5/93; G01S 19/03; G06K 9/00

(52) U.S. Cl. CPC G11B 27/036; G06K 9/00845; H04N 5/9305; G01S 19/03

(57) ABSTRACT

A system for periodically recording GPS coordinates of a vehicle during the vehicle driver's trip as trip coordinates, at times when the driver gazes away from the direction of travel, recording a potential point in interest in accordance with the current GPS coordinates and an angle of the driver's eye gaze, and after reaching the destination, sending the trip coordinates and the point of interest coordinates to a remote server. The remote server may then retrieve from a GPS coordinate-tagged image database, panoramic images corresponding to the trip coordinates and potential POI coordinates. The driver, or any other user of the system, can then create an enhanced time-lapse video of the driver's trip by converting the retrieved panoramic images into a video focusing on points of interest capturing the attention of the driver.

### BACKGROUND

The present disclosure relates to a system, components, and methodologies for time-lapse video generation. In particular, the present disclosure is directed to a system, components, and methodologies that enable generation of enhanced time-lapse video of a vehicle driver's trip using panoramic imagery sources without the need for a camera on board the vehicle.

Time-lapse video may refer to a technique of turning a recording of a scene or objects into a video that plays back at a faster speed than the original recording. In other words, the technique allows one to view changes in a scene without having to wait the actual time. Time-lapse video has become an increasingly popular way for drivers to capture and recreate their travels. For example, hours of actual video drive time may be compressed into a video with merely minutes of playback time, thus creating a time-lapsing effect. This time-lapse video recreates the driver's travel experience in an accelerated manner.

Typically, time-lapse video of a vehicle driver's trip is generated through the use of a camera mounted on the vehicle's dashboard, or on the exterior of the vehicle. Adequately capturing the vehicle's trip requires careful setup of the camera. For example, to have a clear view of a desired scene, the camera must be positioned so as to not be obstructed by other parts of the vehicle. Moreover, without risky user interaction, the camera will usually point forward in the general direction of travel of the vehicle, thus only capturing scenes in front of the vehicle.

Consequently, the camera may miss, or fail to capture scenes or objects that may have captured the driver's attention during his or her drive. More specifically, while driving, the driver may briefly gaze away from the road ahead at a scene or object that catches his or her attention. Unfortunately, because the camera is fixed in the direction of the road in front of the vehicle, the camera may fail to capture the scene or object (i.e., point of interest) that caught the driver's attention.

### SUMMARY

According to the present disclosure, a system is provided for generation of enhanced time-lapse video that may focus on points of interest capturing the driver's attention during the driver's trip without the need for a camera on-board the vehicle.

Disclosed embodiments provide a solution to the above-described technical problems by providing a system for periodically recording GPS coordinates of a vehicle during the vehicle driver's trip as trip coordinates, at times when the driver gazes away from the direction of travel, recording gaze-target information including current GPS coordinates of the vehicle and the angle of the driver's gaze to determine potential points of interest (POIs) and after reaching the destination, sending the trip coordinates and the gaze-target information to a remote server. The server may then retrieve, such as from a GPS coordinate-tagged image database, panoramic images corresponding to the trip coordinates and gaze-target information. The driver, or any other user of the system, can then create an enhanced time-lapse video of the driver's trip by converting the retrieved panoramic images into a video focusing on points of interest capturing the attention of the driver.

In illustrative embodiments, the system comprises a processor, a driver monitoring unit, a GPS module, and a transceiver to communicate with the remote server.

Additional features of the present disclosure will become apparent to those skilled in the art upon consideration of illustrative embodiments exemplifying the best mode of carrying out the disclosure as presently perceived.

### BRIEF DESCRIPTIONS OF THE DRAWINGS

The detailed description particularly refers to the accompanying figures in which:

FIGS. 1A-1D constitute a diagrammatic and perspective view of a travel experience recreation process showing a first point where a device is monitoring the driver while they are driving, a second point where the monitoring device notices when the driver's gaze diverts from the road and records data correlated to what the driver is viewing, a third point where the recorded data is being utilized to create single viewpoint images of what the driver was viewing, and a fourth point where the created single viewpoint images are compiled to produce a narrative of the driver's trip;

FIG. 2 is a block diagram of an exemplary system in accordance with the disclosure focusing on components of the system that reside in the vehicle;

FIG. 3 is a block diagram of an exemplary system, such as the system shown in FIG. 2, now focusing on components of the system that reside in the remote server, in accordance with the disclosure;

FIG. 4 is a diagrammatic view of an illustrative process showing subroutines for visually recreating a driver's travel experience through monitoring the driver, identifying data corresponding to a point-of-interest, and converting the data into single viewpoint images for the driver to view, with the option of uploading the data to remote computers for processing, confirming points-of-interest, and producing a complete narrative of the driver's trip;

FIG. 5 is a diagrammatic view of the monitoring subroutine of FIG. 4 showing operations used to monitor driver inputs during driving;

FIG. 6 is a diagrammatic view of the identifying subroutine of FIG. 4 showing operations used to record data corresponding to a potential point-of-interest when an input signal from the driver is received and utilizing the data in later processes should the driver desire to recreate their driving experience;

FIG. 7 is a diagrammatic view of the communicating and determining subroutines of FIG. 4 showing optional operations used to upload the recorded data from the car to remote computers for processing and allowing the driver to manually select point(s)-of-interest along their driving path, or to have the computer remove false positive points-of-interest automatically based on predetermined points-of-interest, before gathering images used to recreate the driving experience;

FIG. 8 is a diagrammatic view of the converting subroutine of FIG. 4 showing operations used to create single viewpoint images from panoramic images based on the recorded data and point(s)-of-interest;

FIG. 9 is a diagrammatic view of the producing subroutine of FIG. 4 showing optional operations used to create a stop motion video recreating the driver's trip, if the driver desires, by compiling a plurality of single-viewpoint images taken along the driving path in an order based on the recorded time and location data, and storing the single-viewpoint images and/or video for viewing

FIG. 10A is a perspective view showing the driver driving and being monitored at a first point in time;

FIG. 10B is a top-down view of a map showing the drivers location along their travel path at the first point in time;

FIG. 11A is a perspective view showing the monitoring device noticing when the driver's gaze diverts from the road at a later second point in time;

FIG. 11B is a top-down view of a map showing the drivers location along their travel path at the second point in time and that a potential point-of-interest has been marked with corresponding data at the driver's location;

FIG. 12A is a diagrammatic view of the driver's car communicating with a remote computer at a later third point in time;

FIG. 12B is a top-down view of a map showing the driver has reached their destination at the third point in time;

FIG. 13 is a pictorial view of the gathering operation showing the remote computer collecting panoramic images from the image database concurrently with the third point in time;

FIG. 14A is a top-down view of a map showing a single-viewpoint image being captured from a portion of a panoramic image based on the driver's gaze angle at the point-of-interest at a later fourth point in time;

FIG. 14B is a pictorial view of the single-viewpoint image captured from the panoramic image at the fourth point in time; and

FIG. 15 is a pictorial view showing single-viewpoint images captured along the driver's travel path being compiled into a video at a later fifth point in time to produce a trip narrative.

FIG. 16 is a perspective view of a travel experience showing the using of a driver monitoring device in addition to a hard key located on the steering wheel for the capturing of potential points of interest;

FIG. 17 is a diagrammatic view illustrating the use of a navigation system display for capturing potential points of interest of the driver; and

FIG. 18 is a diagrammatic view illustrating the use of a mobile phone camera positioned in the vehicle to capture images during the driver's trip.

### DETAILED DESCRIPTION

The figures and descriptions provided herein may have been simplified to illustrate aspects that are relevant for a clear understanding of the herein described devices, systems, and methods, while eliminating, for the purpose of clarity, other aspects that may be found in typical devices, systems, and methods. Those of ordinary skill may recognize that other elements and/or operations may be desirable and/or necessary to implement the devices, systems, and methods described herein. Because such elements and operations are well known in the art, and because they do not facilitate a better understanding of the present disclosure, a discussion of such elements and operations may not be provided herein. However, the present disclosure is deemed to inherently include all such elements, variations, and modifications to the described aspects that would be known to those of ordinary skill in the art.

Typically, time lapse video of a vehicle driver's trip is generated through the use of a camera mounted on the vehicle's dashboard, or on the exterior of the vehicle. Adequately capturing the vehicle's trip requires careful setup of the camera. For example, to have a clear view of desired scene, the camera must be positioned so as to not be obstructed by other parts of the vehicle. Moreover, without risky user interaction, the camera will usually point forward in the general direction of travel of the vehicle, thus only capturing scenes in front of the vehicle. Therefore, any created time-lapse video may only contain footage of scenes or objects in the direction of the travel of the vehicle.

Consequently, and as noted previously, the camera may miss, or fail to capture scenes or objects that may have captured the driver's attention during his or her drive. For example, oftentimes while driving, the driver may briefly gaze away from the road ahead at a scene or object that catches his or her attention. Unfortunately, because the camera is fixed in the direction of the road in front of the vehicle, the camera may fail to capture the scene or object (i.e., point of interest) that caught the driver's attention.

Disclosed embodiments provide a solution to the above-described technical problems by providing an-vehicle system for periodically recording GPS coordinates of a vehicle during the vehicle driver's trip as trip coordinates, at times when the driver gazes away from the direction of travel, recording gaze-target information including current GPS coordinates of the vehicle and the angle of the driver's gaze to determine potential points of interest (POIs), and after reaching the destination, sending the trip coordinates to a remote server. The remote server may then retrieve from a GPS coordinate-tagged image database, panoramic images corresponding to the gaze-target information as well as images corresponding to the overall trip coordinates. The driver, or any other user of the system, can then create a time-lapse video of the driver's trip by converting the retrieved panoramic images into single-viewpoint images for compilation into a video.

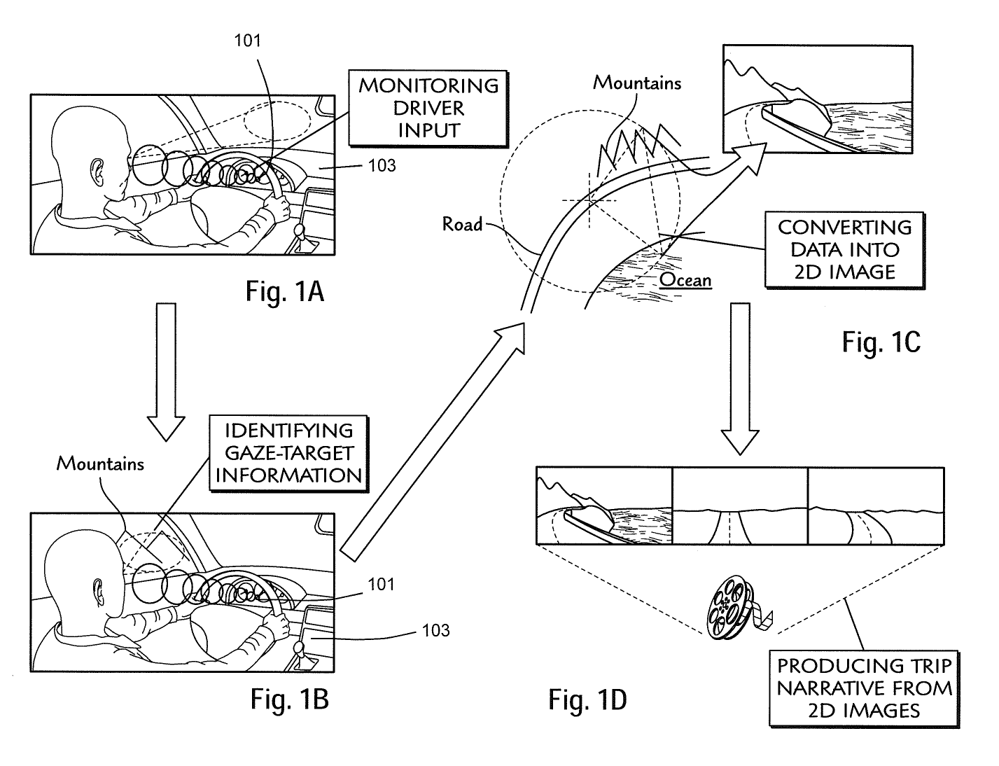

Thus, as illustrated in FIGS. 1A-1D, a system may be designed in accordance with the disclosed embodiments to generate a time-lapse video including any points of interest capturing the driver's attention during the driver's trip without the need for a camera on-board the vehicle. As shown in FIG. 1A, a driver monitoring unit 101 monitors a driver's behavior while driving in a vehicle 103. More specifically, the driver monitoring unit 101 may track, and detect when the driver looks in a different direction than the direction of travel of the vehicle (i.e., the front of the vehicle), or “gazes”. For example, and as shown in FIG. 1B, a scene or object (i.e., a point of interest) such as a mountain range that may be best seen through a side window of the vehicle, may capture the driver's attention. The driver monitoring unit 101 detects when the driver gazes at the mountains and records gaze-target information corresponding to this time of detection. This gaze-target information may include current GPS coordinates of the vehicle (i.e., point of interest coordinates), the angle of the driver's gaze, and the like.

After the driver reaches his or her destination, the vehicle may upload the gaze-target information to a remote server. The remote server is able to retrieve, such as from an image database, panoramic images corresponding to the gaze-target information and convert those images into a time-lapse video as shown in FIG. 1C. Using the gaze-target information, the driver can capture a portion of a panoramic image that represents, more specifically, what the driver may have seen during his trip. In other words, the driver can convert the panoramic images into driver viewpoint, or, as used herein, single-viewpoint images. As such, and referring now to FIG. 1D, the driver has the option to review and edit the images and/or video, producing a customized trip narrative.

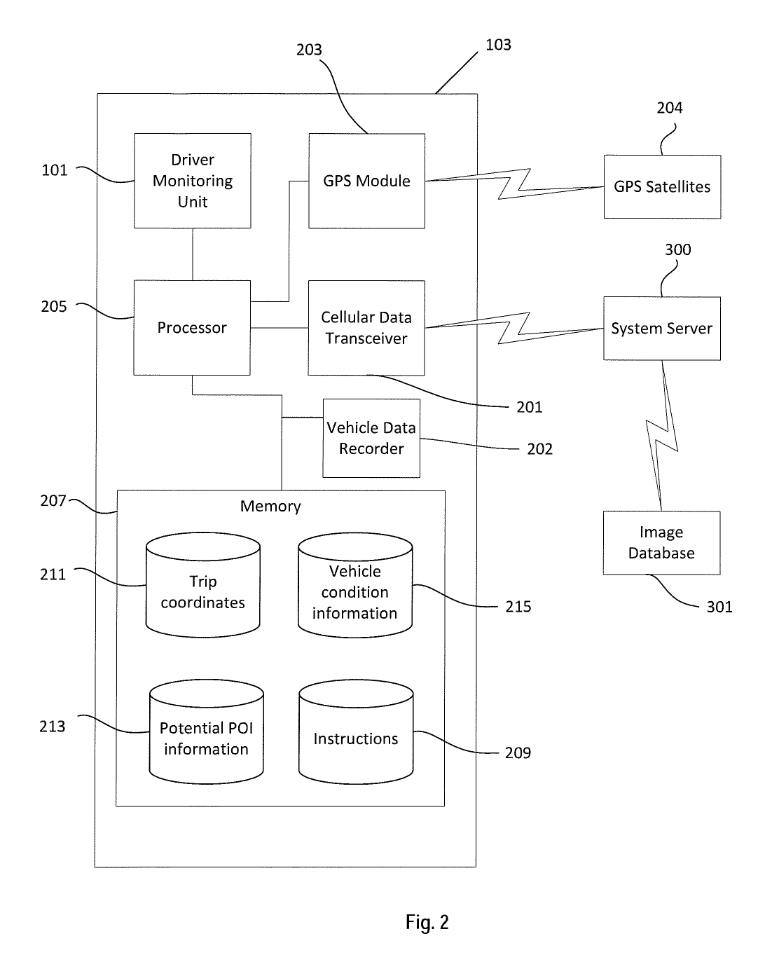

As illustrated in FIG. 2, the vehicle 103 may include various components that enable access to information and communication with one or more servers via a variety of transceivers. Accordingly, the vehicle 103 may include a cellular data transceiver 201, a vehicle data recorder 202, and the driver monitoring unit 101, that may function as explained in connection with FIGS. 1A-1D. The vehicle 103 may also include a Global Positioning System (GPS) module 203, which has the ability to determine the geographic location of the vehicle 103. Operation of the various components included in the vehicle 103 illustrated in FIG. 2 may be dictated or performed under the direction of one or more processors 205, which may be coupled directly or indirectly to each of the various components illustrated in the vehicle 103.

Thus, the processor 205 may be coupled to memory 207 that may incorporate various programs, instructions, and data. For example, as explained in more detail below, the processor 205 may use the GPS module 203 (receiving transmissions from GPS Satellites 204) and instructions 209 to periodically record the vehicle's GPS coordinates during the vehicle driver's trip, and may store them as trip coordinates 211 in the memory 207. The processor 205 may also use the GPS module 203 and the instructions 209 to record the vehicle's GPS coordinates corresponding to times when the driver monitoring unit 101 detects the driver gazing away from the direction of travel of the vehicle 103. In addition to merely detecting when the driver gazes away from the road ahead, the angle at which the driver gazes away from the road ahead may also be recorded. More specifically, the driver monitoring unit may detect the angle made from the direction of the driver's eyes looking straight ahead in the direction of travel, and the direction of the driver's eye gaze. The site(s) determined by the driver's gaze angle at these recorded vehicle locations are referred to herein as potential points of interest (POIs). The potential POIs may be stored in a potential POI database 213.

The processor 205 may also retrieve other vehicle data, such as from the vehicle data recorder 202 (which may be communicatively coupled to other vehicle components such as the speedometer, RPM gauge, etc.), information such as the current speed of the vehicle 103, current revolutions per minute (RPMs) of the motor of the vehicle 103, and the like, and stored in the memory 207 in a vehicle condition information database 215.

Thus, the in-vehicle system components are able to record and store trip coordinates, potential POI information, as well as other vehicle data at these detected points in time, such as the current speed of the vehicle, RPMs of the motor of the vehicle, and the like. This recorded data and information coordinates and other vehicle data can then be used for creation of a time-lapse video including highlights of points of interest capturing the attention of the driver.

To enable the creation of a time-lapse video, the above discussed in-vehicle components communicate with various off-vehicle, or remote, components associated with the system. Thus, the cellular data transceiver 201 or the like may be utilized to communicate with one or more remote servers 300, which in turn communicate with one or more GPS-coordinate tagged image databases 301. Image database 301 may comprise real world imagery such as from map services known as Google® “Street View”. This real world imagery may include immersive 360° panoramic views at a street level. Communication between the system server(s) 300 and the image database(s) 301 may be performed via wired or wireless connections, e.g., via the Internet and/or any other public and/or private communication network.

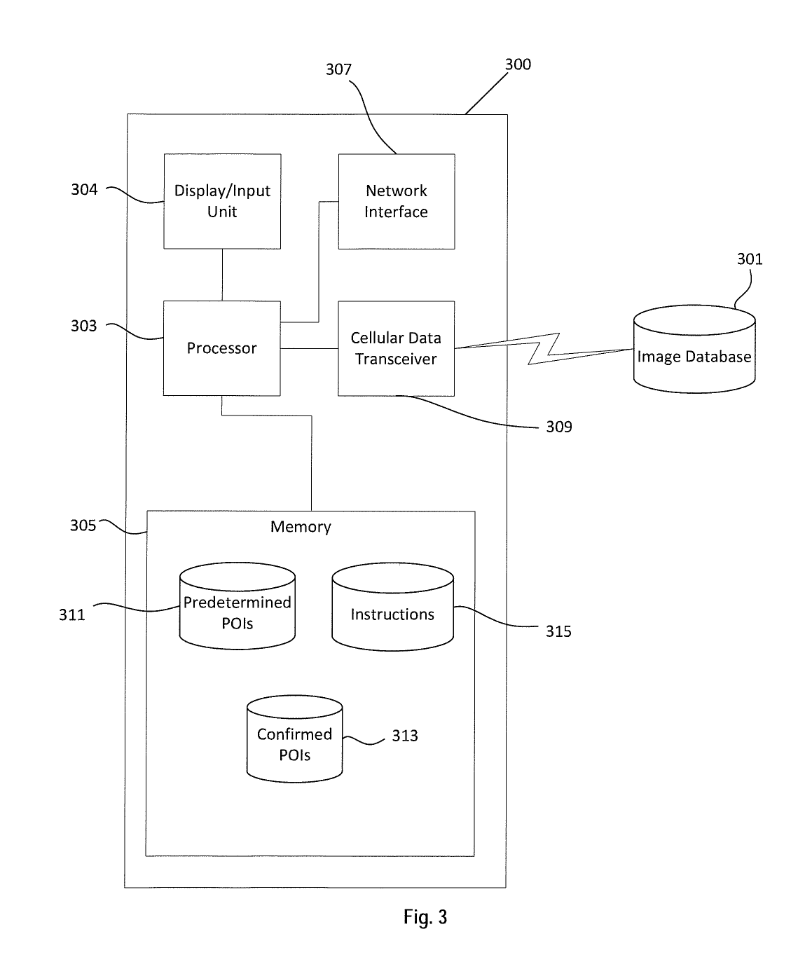

FIG. 3 illustrates one example of the constituent structure of a system server 300. As shown in FIG. 3, the system server 300 may include one or more processors 303 coupled to and accessing and storing data and instructions in the memory 305. The system server 300 may also include a display/input interface 304 for use by a driver or other user for the entry of instructions for the viewing and creating of the trip video. In order to provide the ability to communicate with the image database 301, the system server 300 may include or be coupled to a network interface 307. Likewise, in order to communicate with the in-vehicle components, the system server 300 may include or be coupled to a cellular transceiver 309. The memory 305 may include various instructions and data accessible by the processor(s) 303 to provide the functionality disclosed herein. Thus, the memory 305 may include a database of coordinates of predetermined points of interest 311 as well as any potential POI coordinates received from the vehicle 103. The predetermined POI database 311 may include coordinates of scenes or objects previously identified, validated, and recorded by drivers or observers as being useful or interesting. Thus, in some embodiments, the system server 300 may compare the potential POI coordinates with the predetermined POI coordinates. This comparison may serve to eliminate any false positive points of interest, or, in other words, coordinates recorded at times when the driver gazed away from the road for reasons other than scenes or objects that caught his or her attention. For example, the driver may have gazed away from the road ahead to check his mobile phone, or change lanes. Thus, after performing this comparison, only those potential POI coordinates matching the predetermined POI coordinates are retained as confirmed point of interest coordinates stored in database 313. The memory may also include instructions 315 for carrying out the creation of the time-lapse video of the driver's trip.

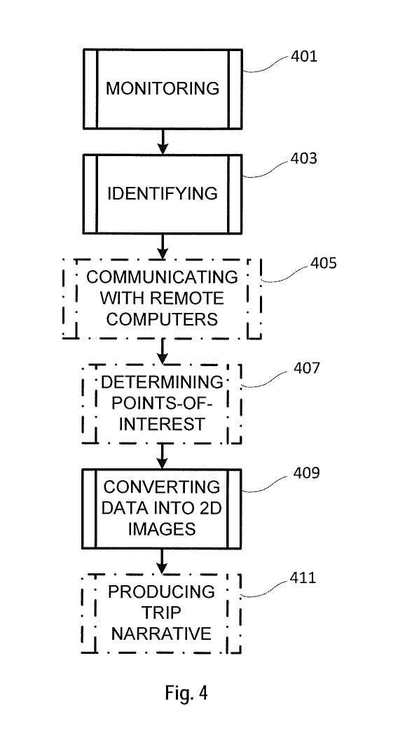

Thus, in light of the foregoing, and as shown generally in FIG. 4, embodiments of the disclosure include a system for visually recreating a driver's travel experience through first monitoring the driver at 401. Next, data corresponding to potential POIs is identified at 403. Optionally, at 405, after the driver reaches his destination, the data may be uploaded to remote servers 300, and, at 407, the POIs may be confirmed. At 409, the data may then be converted into single-viewpoint images, and then, optionally, at 411, a time-lapse video narrative of the driver's trip may be produced from the images.

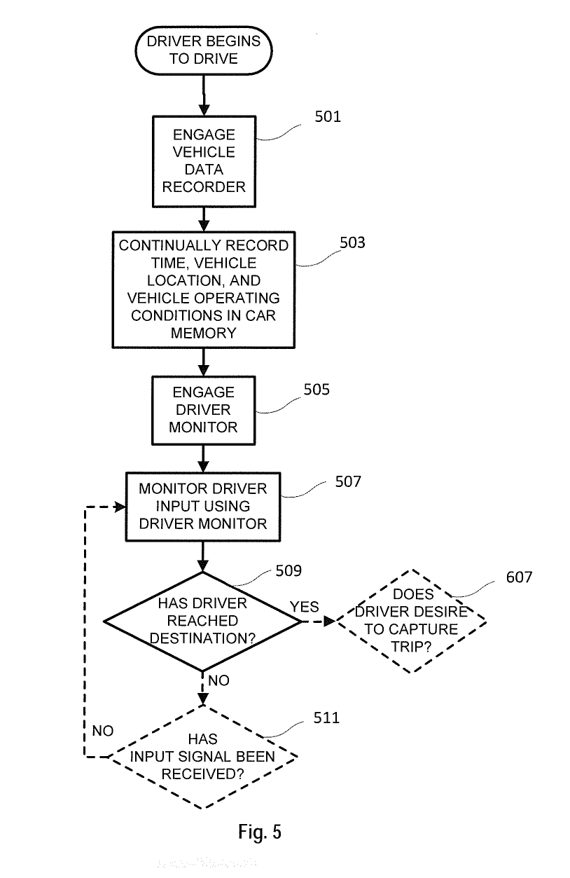

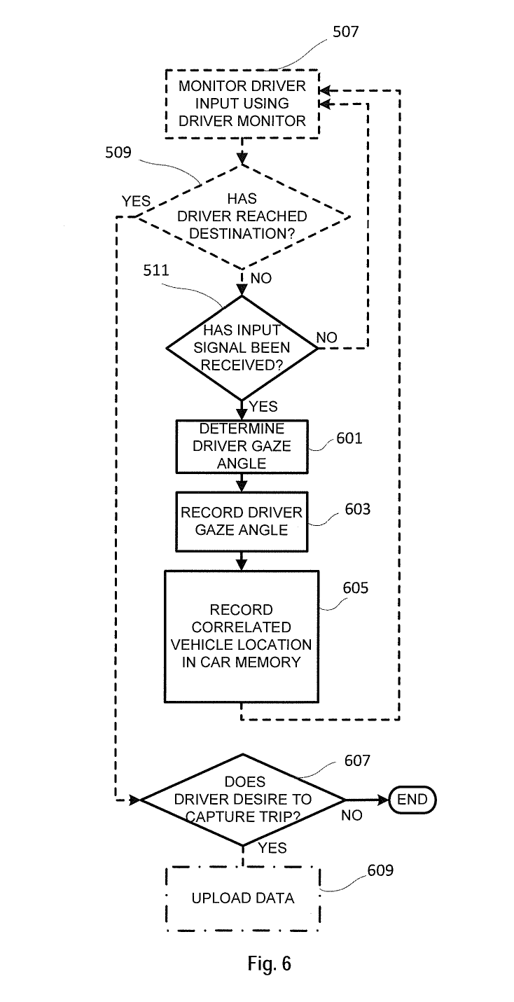

FIG. 5 is a diagrammatic view of the monitoring subroutine 401 of FIG. 4 showing operations used to monitor driver inputs during driving. Once the driver begins to drive, the vehicle data recorder 202 is engaged at step 501. While the driver is driving, at step 503, the vehicle data recorder 202 continually records vehicle data including timestamps corresponding to times of recordation of other vehicle information such as GPS coordinates and vehicle operating conditions in the memory (such as memory 207 shown in FIG. 2). At step 505, the driver monitoring unit 101 may be engaged. At step 507, the driver monitoring unit 101 may monitor the driver's input until the driver reaches his destination, which is determined by decision step 509. At step 511, the driver monitoring unit 101 will continue to check for a driver input signal until the driver reaches his or her destination. As discussed herein throughout, this input may be in the form of the driver's eye gaze away from the road ahead. If it is determined that the driver input has been received, the monitoring subroutine 401 proceeds to the identifying subroutine 403 of FIG. 6.

FIG. 6 is a diagrammatic view of the identifying subroutine 403 of FIG. 6 showing operations used to record information corresponding to a potential point-of-interest when an input signal from the driver is received. When the driver input has been received, and more specifically, when the driver gazes away from the road ahead, the driver monitoring unit 101 determines gaze-target information (such as the driver gaze angle at step 601 and records this angle at step 603. At step 605, the site(s) determined by the gaze angle correlating to the GPS coordinates of the vehicle (potential POI coordinates) are recorded.

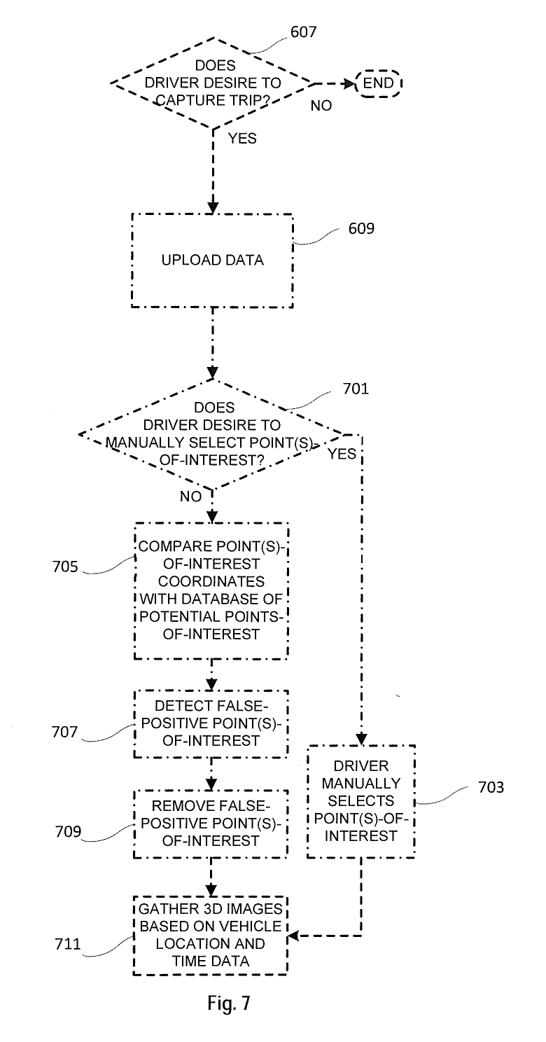

Once the driver reaches his or her destination, if the driver wishes to capture his or her trip at decision step 607, the recorded data will be uploaded to the remote server 300, and the identifying subroutine 403 proceeds to the communicating and determining subroutines 405 and 407, respectively, of FIG. 4. FIG. 7 is a diagrammatic view showing optional operations used to upload the recorded data from the car to the remote server(s) 300. As discussed previously in FIG. 6, if the driver wishes to capture his or her trip at decision step 607, the above discussed recorded data (e.g., trip coordinates, gaze-target information, vehicle data, and the like) may be uploaded to the remote server(s) 300, at 609. At decision step 701, the driver has the option to manually select from the predetermined POI coordinates to be considered as points of interest. If so, the driver may proceed to selecting from the predetermined POIs using the user interface 304 at step 703. If the driver does not wish to perform this function manually, at step 705, the remote server 300 may compare the potential POI coordinates with the database of coordinates of predetermined points of interest, such as from the POI database 311 of FIG. 3. Potential POI coordinates that do not match (i.e., are not substantially similar to) the GPS coordinates of the predetermined points of interest are flagged as false positive points of interest at step 707, and are removed at step 709. Potential POI coordinates that match the GPS coordinates of the predetermined points of interest are flagged as confirmed points of interest, or scenes or objects that captured the driver's attention. At step 711, panoramic images are retrieved from the image database (such as the Google® Street View image database) based on the matched coordinates, along with the overall trip coordinates along with other vehicle data and gaze-target information. Also, because timestamp information (e.g. time-of-day information) was also recorded, the images and eventual video captured could be retrieved and produced to be under similar lighting conditions. For example, if the driver was driving from 10:30 pm to 11:30 pm Eastern Standard Time, because of the timestamps, the remote server 300 may retrieve panoramic images that have similar lighting conditions to that of the driver during his travel experience (in this case, at night). This may allow the driver to create a trip video more accurately depicting the driver's travels.

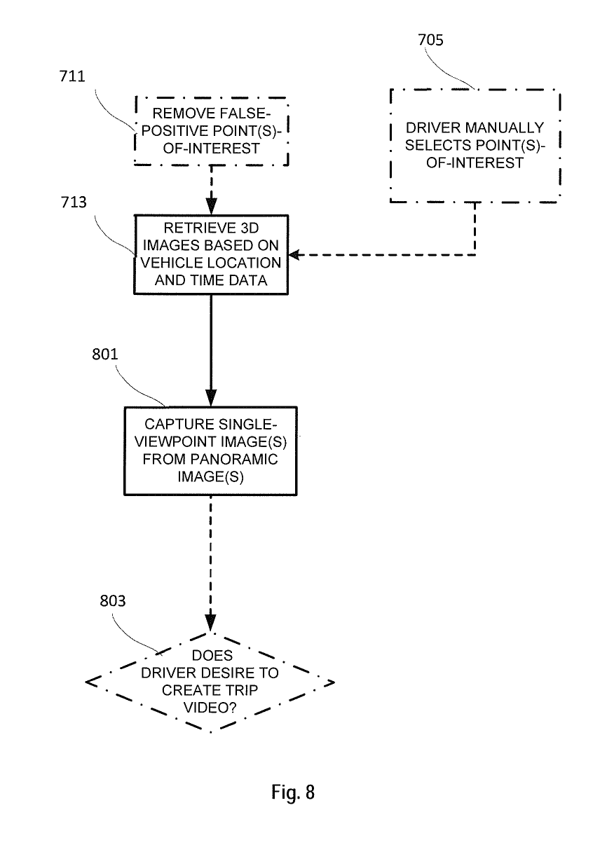

After the panoramic images are gathered, the converting subroutine 409 of FIG. 4 may be performed, a diagrammatic view of which is shown in FIG. 8. For example, FIG. 8 is a diagrammatic view of the converting subroutine of FIG. 4 showing operations used to create single-viewpoint images from the panoramic images based on the recorded data, trip coordinates, and confirmed points of interest. After having retrieved the panoramic images from the image database 301, the system may perform additional processing to allow for even more accurate capturing of points of interest. More specifically, by further employing the recorded driver gaze angles, the system can capture specific portions of a point of interest that caught the driver's attention. Because the images from the database are “panoramic”, they have an elongated field of view consisting of what can be considered as multiple viewpoints stitched together. Embodiments of the disclosure can choose to focus on a particular part of the entire panoramic image that caught the driver's attention. For example, the panoramic image may be of a mountain range, as well as other objects in a view surrounding the vehicle. By using the driver's gaze angle, the system is able to pinpoint exactly what object(s) or scene within the entire panoramic view, at which the driver was gazing. Accordingly, the system is able to capture a single viewpoint image (i.e., an image consisting of a portion of the overall panoramic image that the driver was actually seeing during his or her drive) based on the driver's gaze angle, at step 801. The driver determines, at step 803, if he or she wishes to create the trip video.

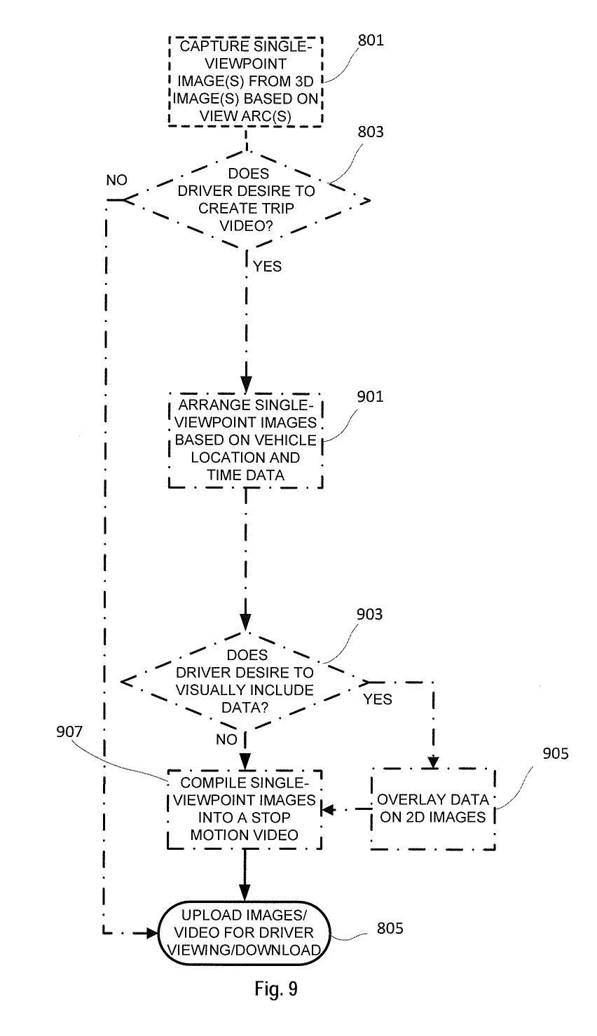

FIG. 9 is a diagrammatic view of the producing subroutine of FIG. 4 showing optional operations used to create a video recreating the driver's trip. As shown, at step 803, if the driver does not desire to create a trip video, the captured images and other vehicle information may be stored/downloaded for later use at step 805. Alternatively, if the driver desires to create a trip video, the system arranges the converted single-viewpoint images at step 901 based on timestamps and other vehicle data. At step 903, the system determines if the driver wishes to include other data as well. This other data may include any of the above-discussed recorded vehicle data such as the speed of the vehicle, RPMs, and the like. As such, at step 905, this data may be inserted as a visual overlay on the single-viewpoint images. Visual inclusion of some of this data may act to further enhance the video. For example, the driver may wish to have shown on the video, his speed at particular points during his trip. This speed could be visual overplayed on the video. Therefore, at step 907, the single-viewpoint images, along with any additional vehicle data, may be threaded together to create the time-lapse video sequence. Embodiments of the disclosure allow for other production techniques providing further video enhancements. For example, the driver could remove certain sections of the trip and/or extend (i.e., “slow down”) sections he or she wishes to highlight. The driver could also choose to augment the video with audio in the form of music and/or a personal narrative. As mentioned above, the driver can then store and/or download the created trip and captured images at step 805.

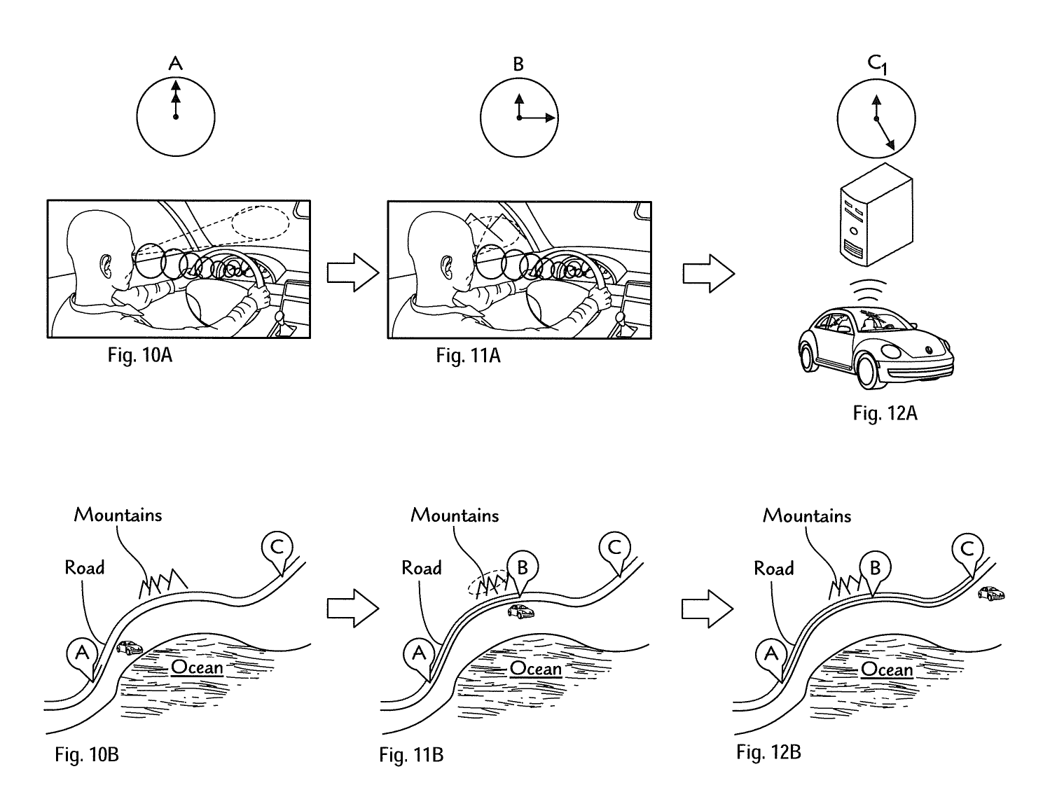

Thus, in light of the foregoing, as illustrated in FIGS. 10A, 10B, 11A, 11B, 12A and 12B, a system may be designed in accordance with the disclosed embodiments to generate a time-lapse video including any points of interest capturing the driver's attention during the driver's trip without the need for a camera on-board the vehicle. FIG. 10A is a perspective view showing the driver driving and being monitored at a first point in time. FIG. 10B is a top-down view of a map showing the driver's location along their travel path at the first point in time. FIG. 11A is a perspective view showing the monitoring device noticing when the driver's gaze diverts from the road at a later second point in time. FIG. 11B is a top-down view of a map showing the driver's location along his or her travel path at the second point in time and that a potential point-of-interest has been marked with corresponding data at the driver's location. After the driver reaches his or her destination, the vehicle may upload the gaze-target information to a remote server. FIG. 12A is a diagrammatic view of the driver's car communicating with the remote server(s) at this third point in time. FIG. 12B is a top-down view of a map showing the driver has reached their destination at this third point in time.

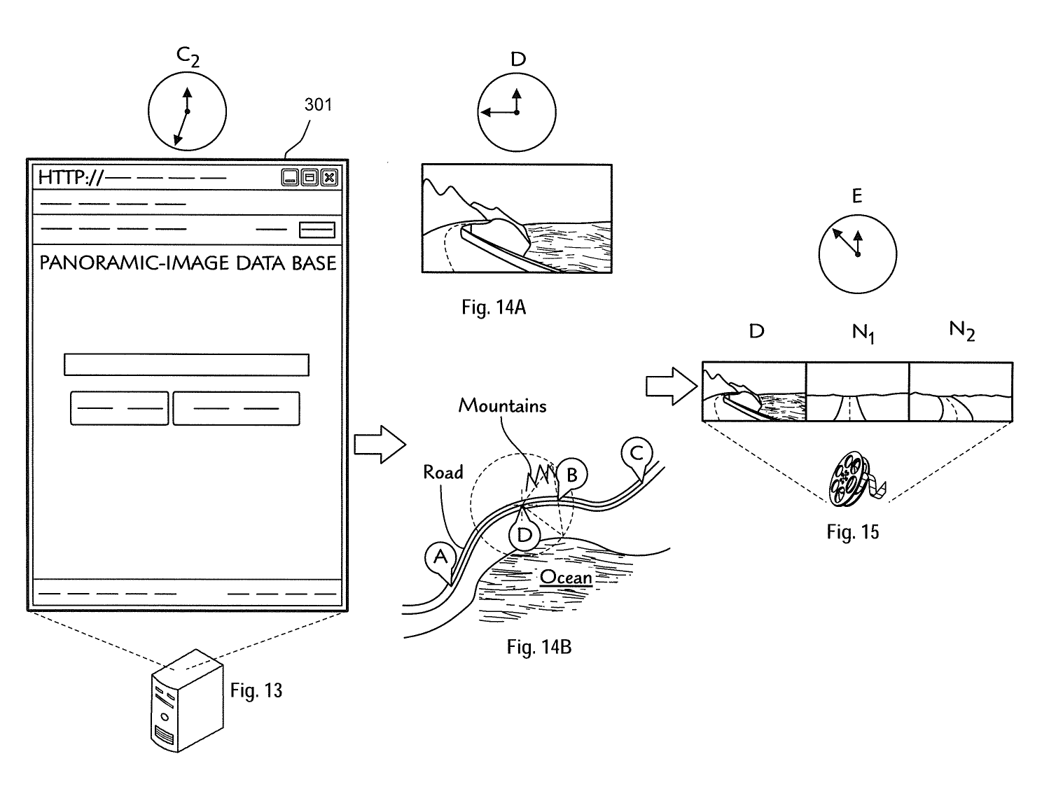

As shown in FIG. 13, the remote server is able to retrieve, such as from an image database, panoramic images corresponding to the gaze-target information and trip coordinates. Referring now to FIG. 14A, a single-viewpoint image is shown being captured from a portion of a panoramic image based on the driver's gaze angle at the point-of-interest at a later fourth point in time. FIG. 14B is a top-down view of the single-viewpoint image captured from the retrieved panoramic image at the fourth point in time.

The driver then has the option to review and edit the video, producing a customized trip narrative. FIG. 15 is a pictorial view showing single-viewpoint images captured along the driver's travel path being compiled into a video at a later fifth point in time to produce this trip narrative.

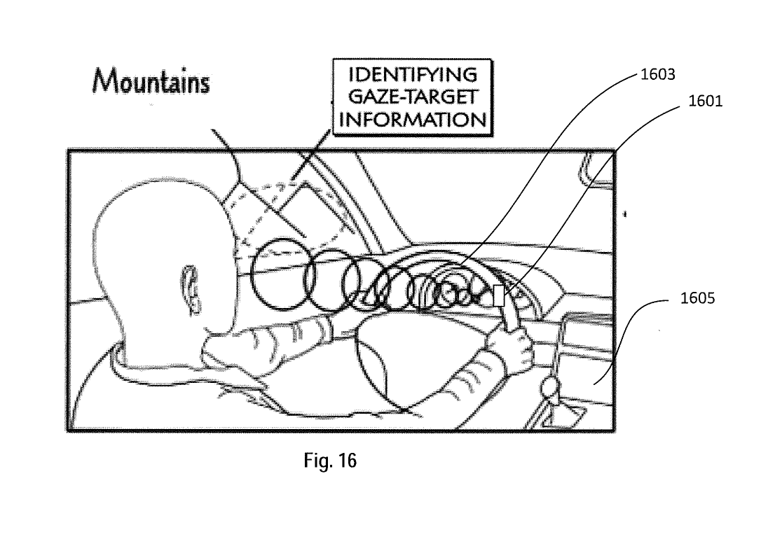

Embodiments of the disclosure include additional techniques for capturing points of interests during a driver's travels. In one alternative technique, the instructions 209 may cause the vehicle 103 to record GPS coordinates and other gaze target information, upon the driver pressing a hard key simultaneously with the driver's gaze away from the road ahead. As illustrated in FIG. 16, the hard key 1601 may be located on, or communicably coupled to the steering wheel 1603. However, the hard key 1601 may be located on other components, such as a navigation system 1605.

Alternatively, or in addition to, a driver monitoring system, the vehicle 103 may include a three-dimensional recognition system. In this embodiment, potential points of interest will be recorded when the driver makes a certain gesture (e.g., pointing an index finger in a direction). The direction of the gesture will be recorded for comparison to the predetermined points of interest at the remote server.

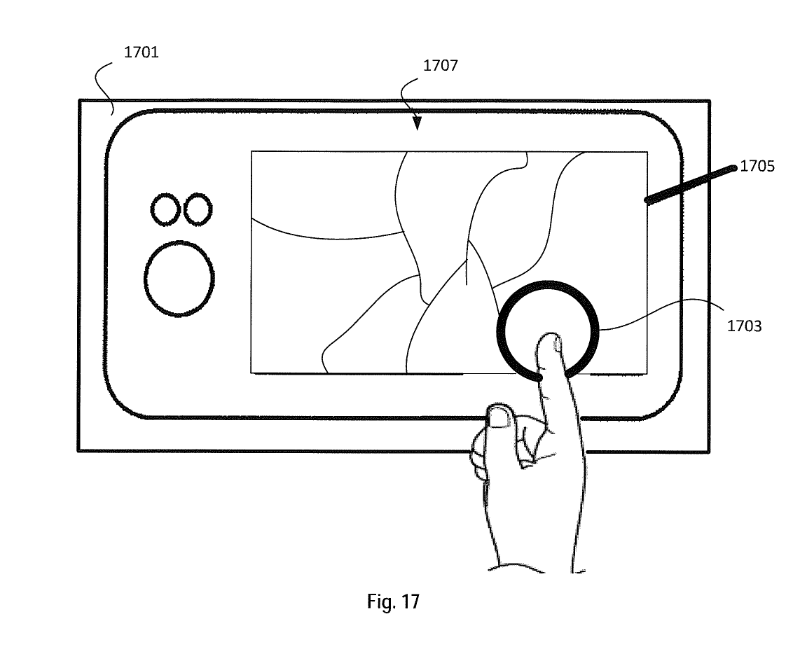

Embodiments of the disclosure may employ the use of a navigation system. For example, as shown in the console 1701 of the vehicle 103 in FIG. 17, the driver may gesture to (e.g., point, depress, encircle, or the like) a particular area 1703 corresponding to a point of interest on the map display screen 1705 of the navigation system 1707. This point of interest will then be recorded by the vehicle 103 for use in creation of a trip video after the driver reaches his destination.

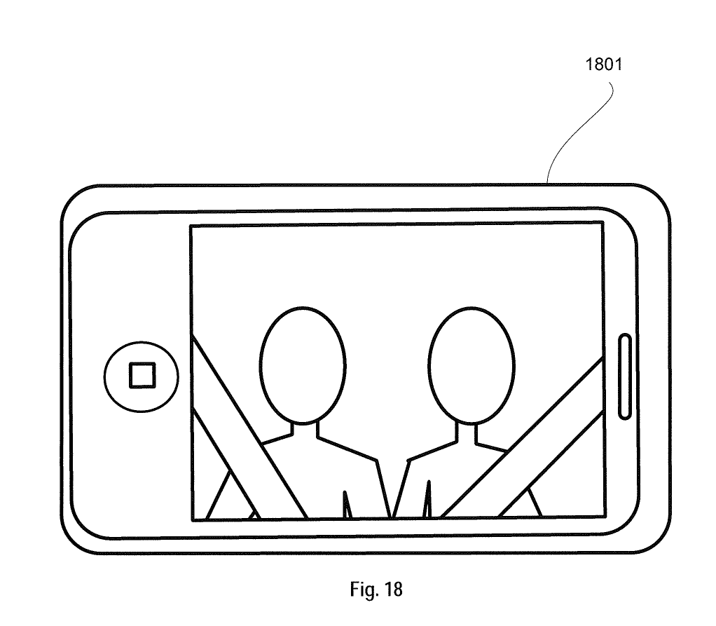

To further personalize the trip video, the driver (or any other user) can insert images with location information (via a mobile phone application or camera) into the trip video. For example, and as shown in FIG. 18, a mobile phone 1801 may be positioned to capture images of the interior of the vehicle 103 (e.g., to highlight passengers) or exterior of the vehicle 103 (e.g., to highlight of point of interest, detect landmarks, or further refine a highlighted point of interest). These images can also be included in the trip video.

In light of the foregoing, the system may store any number of driver metrics, vehicle data, and the like. This information may be used in many ways. For example, this information may be considered valuable to other users wishing interested in the particular route taken by another driver. By continually collecting and compiling more information (e.g., trip images, video, vehicle data) from more and more drivers, the system may be able to identify, for example, static road characteristics, one-way roads, two-way roads, dead ends, junctions of different types, allowable and unallowable turns, roundabouts, speed bumps, overpasses, underpasses, tunnels speed limits, traffic lights, traffic signs, gas stations, parking lots, and other points of interest. This information may be helpful, for example, to a driver looking to shave time off his or her regular commute by showing him or her new routes. As such, over time, the system's database of information potentially becomes more and more useful to drivers and other users of the system. Further, this information may be used to create, or in conjunction with mobile applications (apps), such as social navigation applications, or social video applications.

The disclosed embodiments differ from the prior art in that they provide a system and methodologies for enhancing a time-lapse video that may focus on points of interest capturing the driver's attention during the driver's trip without the need for a camera on-board the vehicle. Conventional technology enables the creation of a time-lapse video (e.g., http://hyperlapse.tllabs.io). However, it fails to allow for enhancements of the video. For example, no driver can create a video focusing on points of interests capturing his or her attention, allowing for a more customized recreation of the travel experience without the use of an on-board camera. Other enhancements, as discussed herein throughout also distinguish embodiments of the disclosure herein, from the prior art.

Thus, according to the present disclosure, a system is provided for generation of enhanced time-lapse video that may focus on points of interest capturing the driver's attention during the driver's trip without the need for a camera on-board the vehicle.

Although certain embodiments have been described and illustrated in exemplary forms with a certain degree of particularity, it is noted that the description and illustrations have been made by way of example only. Numerous changes in the details of construction, combination, and arrangement of parts and operations may be made. Accordingly, such changes are intended to be included within the scope of the disclosure, the protected scope of which is defined by the claims.

1. A system for creating a video of a vehicle's trip from an origin to a destination, comprising:
a vehicle in operative communication with a server, having:
a first processor in data communication with:
a global positioning system (GPS) module;
a first cellular data transceiver;
means for detecting when a driver gazes away from the road ahead and toward a potential point of interest; and
a non-transitory storage device on which is stored computer readable code which, when executed by the first processor, causes the vehicle to:
periodically record the vehicle's GPS coordinates during the trip as trip coordinates;
when the driver's eye gaze is detected, record a potential point of interest in accordance with the vehicle's GPS coordinates and an angle of the driver's eye gaze;
after the vehicle reaches the destination, send the periodically recorded trip coordinates and the potential point of interest to the server via the cellular data transceiver; and
the server having:
a second processor in data communication with:
a second cellular data transceiver; and
a point of interest database containing GPS coordinates of predetermined points of interest; and
means for comparing the recorded potential point of interest to the GPS coordinates of the predetermined points of interest to determine confirmed point of interest coordinates;
means for retrieving from a GPS coordinate-tagged image database, images corresponding to the confirmed point of interest coordinates and the trip coordinates; and
means for converting the retrieved images into a time-lapse video of the vehicle's trip.

2. The system of claim 1, wherein the computer readable code causes the vehicle to record, at the same time the driver gazes away from the road, at least one of a current speed of the vehicle, a current revolutions per minute rate of a motor of the vehicle, and a current time of day.

3. The system of claim 2, wherein the retrieved images correspond to the time of day the driver gazed away from the road.

4. The system of claim 1, wherein the computer readable code causes the vehicle to record a correlation between a current vehicle location and the angle of the driver's eye gaze.

5. A vehicle in operative communication with a server and configured to operate as part of a system for creating a video of the vehicle's trip from an origin to a destination, the vehicle comprising:
a processor in data communication with:
a global positioning system (GPS) module;
a cellular data transceiver;
a driver monitoring unit configured to detect a driver trigger as a potential point of interest; and
a non-transitory storage device on which is stored computer readable code which, when executed by the processor, causes the vehicle to:
periodically record the vehicle's geographic coordinates during the trip as trip coordinates;
record a potential point of interest in accordance with the vehicle's GPS coordinates and an angle of the driver's eye gaze; and
after the vehicle reaches the destination, send the periodically recorded trip coordinates and the potential point of interest coordinates to the server via the cellular data transceiver.

6. The vehicle of claim 5, wherein the driver trigger comprises a driver's gaze away from a road in front of the driver.

7. The vehicle of claim 5, wherein the driver trigger comprises the driver depressing a key substantially contemporaneously with the driver's gaze away from the road.

8. The vehicle of claim 5, wherein the driver monitoring unit is further configured to detect a direction of a gesture of the driver.

9. The vehicle of claim 5, further comprising a navigation display, wherein the driver trigger comprises the driver highlighting the potential point of interest on the navigation display.

10. The vehicle of claim 5, wherein the video can include at least one of an image taken from the interior of the vehicle and an image of the confirmed points of interest taken from the exterior of the vehicle.

11. A server configured to operate as part of a system for creating a video of the vehicle's trip from an origin to a destination, comprising:
a processor in data communication with:
a cellular data transceiver configured to receive:
trip coordinates corresponding to periodically recorded geospatial positioning system (GPS) coordinates of the vehicle during the trip;
a potential point of interest based on vehicle GPS coordinates and an angle of the driver's eye gaze when a trigger event of a driver of the vehicle is detected; and
record a site in accordance with the vehicle's GPS coordinates and an angle of the
driver's eye gaze as a potential point of interest a non-transitory storage device on which is stored:
a point of interest database containing geospatial positioning system (GPS) locations of predetermined points of interest; and
computer readable code which, when executed by the processor, causes the server to:
compare the received potential points of interest GPS and the predetermined points of interest to determine confirmed point of interest coordinates;
retrieve from a GPS coordinate-tagged image database, images corresponding to the confirmed point of interest coordinates and the received trip coordinates; and
convert the images into the video of the trip.

12. The server of claim 11, wherein the retrieved images correspond to a time of day the driver gazed away from a road in front of the driver.

13. The server of claim 11, wherein the video includes vehicle operating condition information comprising at least one of: a current speed of the vehicle and a current revolutions per minute (RPM) rate of a motor of the vehicle.

14. The server of claim 11, wherein the computer code causes the server to additionally retrieve images in accordance with the angle of the driver's gaze.

15. The server of claim 11, wherein the images comprise street-view panoramic images.

16. A method for creating a video of a vehicle's trip from an origin to a destination, the method comprising:
periodically recording geospatial positioning system (GPS) coordinates of the vehicle during the trip as trip coordinates;
detecting a driver trigger event as a potential point of interest;
recording GPS coordinates and a driver's gaze angle when the driver trigger is detected as potential point of interest coordinates; and
after reaching the destination, sending the trip coordinates and the potential point of interest coordinates to a remote server.

17. The method of claim 16, wherein the driver trigger comprises a driver's gaze away from the road in front of the driver.

18. The method of claim 16, wherein the driver trigger comprises the driver depressing a key substantially contemporaneously with the driver's gaze away from the road.

19. The method of claim 16, wherein the detecting a driver trigger comprises detecting a direction of a gesture of the driver.

20. The method of claim 16, further comprising a navigation display, wherein the driver trigger comprises the driver highlighting the potential point of interest on the navigation display.

21. A method for creating a video of a vehicle's trip from an origin to a destination, the method comprising:
retrieving trip coordinates from the vehicle, wherein the trip coordinates correspond to periodically recorded geospatial positioning system (GPS) coordinates of the vehicle during the trip;
retrieving potential point of interest corresponding to vehicle GPS coordinates recorded when a trigger event of a driver of the vehicle is detected and an angle of the driver's eye gaze;
comparing the potential point of interest with locations of predetermined points of interest to determine confirmed point of interest coordinates;
retrieving, from a GPS coordinate-tagged image database, images corresponding to both the confirmed point of interest coordinates and the trip coordinates; and
converting the images into a time-lapse video of the trip.

22. The method of claim 21, wherein the retrieved images correspond to the time of day the driver gazed away from the road in front of the driver.

23. The method of claim 21, wherein the video includes vehicle operating condition information comprising at least one of a current speed of the vehicle and a current revolutions per minute (RPM) rate of a motor of the vehicle.

24. The method of claim 21, wherein the retrieving further comprises retrieving images in accordance with the angle of the driver's eye gaze.

25. The method of claim 21, wherein the images comprise street-view panoramic images.
